(19) United States
(12) Patent Application Publication
(10) Pub. No.: US 2025/0161839 A1
(43) Pub. Date: May 22, 2025

(54) METHOD AND SYSTEM FOR THE CAPTURE OF MICROPLASTICS

(71) Applicant: Northwestern University, Evanston, IL (US)

(72) Inventors: Chloe Mae Pui Ho, Evanston, IL (US); Leyun Feng, Evanston, IL (US); Kyoo-Chul Kenneth Park, Evanston, IL (US)

(21) Appl. No.: 18/950,640

(22) Filed: Nov. 18, 2024

Related U.S. Application Data
(60) Provisional application No. 63/600,275, filed on Nov. 17, 2023.

(51) Int. Cl. B01D 15/10; B01J 20/26; B01J 20/28; B01J 20/32; C02F 1/28; C02F 101/30

(52) U.S. Cl. CPC B01D 15/10; B01J 20/262; B01J 20/28023; B01J 20/3212; B01J 20/3295; C02F 1/288; C02F 1/285; C02F 2101/30

(57) ABSTRACT

A microplastic capture system includes a base and a plurality of hair-like protrusions mounted to and extending from the base. An oil is applied to the plurality of hair-like protrusions. The oil and hair-like protrusions are positioned to capture microplastic particles due to interfacial forces that oppose a force generated by momentum of the microplastic particles.

### CROSS-REFERENCE TO RELATED APPLICATION

The present application claims the priority benefit of U.S. Provisional Patent App. No. 63/600,275 filed on Nov. 17, 2023, the entire disclosure of which is incorporated by reference herein.

### BACKGROUND

Microplastics refer to small pieces of plastic waste that are found in the environment. Microplastic debris result from the disposal and/or breakdown of plastic materials found in consumer products, industrial waste, etc. Microplastics are found throughout the environment, but are especially prominent in bodies of water that receive microplastics as a result of pollution and runoff due to rainstorms, etc. As a result, microplastics have been detected in drinking water, including bottled water and in tap water at numerous locations around the world.

### SUMMARY

An illustrative microplastic capture system includes a base, a plurality of hair-like protrusions mounted to and extending from the base, and an oil applied to the plurality of hair-like protrusions. The oil and hair-like protrusions are positioned to capture microplastic particles due to interfacial forces that oppose a force generated by momentum of the microplastic particles. In one embodiment, the hair-like protrusions have varying aspect ratios across the base. In another embodiment, the hair-like protrusions have varying shapes along the base. In another embodiment, a density of the hair-like protrusions varies along the base. In one embodiment, the hair-like protrusions have one or more secondary branch extensions that extend therefrom.

In another embodiment, the base has a plurality of through-holes such that fluid is able to flow through the base. In another embodiment, the hair-like protrusions extend from an upstream facing side of the base. In one embodiment, the base is incorporated into a housing that includes an inlet for fluid flow and an outlet for the fluid flow. In another embodiment, an inner surface of the housing includes a surfactant coating to attract the microplastic particles. In another embodiment, the hair-like protrusions have a truncated cone shape. In another embodiment, the hair-like protrusions have a cylindrical shape.

An illustrative method of forming a microplastic capture system includes forming a base, and forming a plurality of hair-like protrusions that extend from the base. The method also includes applying an oil to the plurality of hair-like protrusions, where the oil and hair-like protrusions are positioned to capture microplastic particles due to interfacial forces that oppose a force generated by momentum of the microplastic particles.

In one embodiment, the method includes forming the hair-like protrusions to have varying aspect ratios across the base. In another embodiment, the method includes forming the hair-like protrusions to have varying shapes along the base. In another embodiment, the method includes varying a density of the hair-like protrusions along the base. In one embodiment, the method includes forming one or more secondary branch extensions that extend from the hair-like protrusions. In another embodiment, the method includes forming a plurality of through holes in the base such that fluid is able to flow through the base. The method can also include forming the hair-like protrusions such that the hair-like protrusions extend from an upstream facing side of the base. The method can also include mounting the base in a housing that includes an inlet for fluid flow and an outlet for the fluid flow. The method can further include applying a surfactant coating to an inner surface of the housing to attract the microplastic particles.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a substrate, the substrate with hair-like protrusions, and various types of hair-like protrusions in accordance with an illustrative embodiment.

FIG. 2 depicts a cylindrical surface with hair-like structures extending therefrom in accordance with an illustrative embodiment.

FIG. 3A depicts insertion of a hairy surface into an aqueous environment with microplastics in accordance with an illustrative embodiment.

FIG. 3B depicts first movement of the hairy surface within the aqueous environment in accordance with an illustrative embodiment.

FIG. 3C depicts second movement of the hairy surface within the aqueous environment in accordance with an illustrative embodiment.

FIG. 3D depict insertion of the hairy surface into a flowing aqueous solution in accordance with an illustrative embodiment.

FIG. 3E depicts a first flow direction of the aqueous solution relative to the hairy surface in accordance with an illustrative embodiment.

FIG. 3F depicts a second flow direction of the aqueous solution relative to the hairy surface in accordance with an illustrative embodiment.

FIG. 4A depicts the capture of a plurality of microplastic particles on a smooth cylindrical surface in accordance with an illustrative embodiment.

FIG. 4B depicts the capture of microplastic particles on a hairy cylindrical surface in accordance with an illustrative embodiment.

FIG. 4C depicts the capture of microplastic particles on a smooth flat surface in accordance with an illustrative embodiment.

FIG. 4D depicts the capture of microplastic particles on a hairy flat surface in accordance with an illustrative embodiment.

FIG. 5A depicts the shape that oil, e.g. silicone oil, (with dye) takes in Deionised water (DI water), when the oil droplet attaches to a digital light processing (DLP) 3D printed hairy cylindrical surface in accordance with an illustrative embodiment.

FIG. 5B depicts the shape that oil (with dye) takes in DI water, when the oil droplet attaches to a DLP 3D printed hairy flat surface in accordance with an illustrative embodiment.

FIG. 5C depicts the shape that oil (with dye) takes in DI water, when the oil droplet attaches to a Polydimethylsiloxane (PDMS) surface in accordance with an illustrative embodiment.

FIG. 6A depicts the capture of a plurality of microplastics particles for a DLP 3D printed hairy cylindrical surface in accordance with an illustrative embodiment.

FIG. 6B depicts a DLP 3D printed hairy cylindrical surface covered in oil (with dye) in accordance with an illustrative embodiment.

FIG. 6C depicts a DLP 3D printed hairy flat surface in accordance with an illustrative embodiment.

FIG. 6D depicts a DLP 3D printed hairy flat surface covered in oil (with dye) in accordance with an illustrative embodiment.

FIG. 6E depicts a smooth flat PDMS surface in accordance with an illustrative embodiment.

FIG. 6F depicts a smooth flat PDMS surface covered in oil (with dye) in accordance with an illustrative embodiment.

FIG. 7A depicts the capture of microplastics capture using hair structures in 3.5 wt % NaCl solution (simulated seawater environment) for a DLP 3D printed hairy cylindrical surface in accordance with an illustrative embodiment.

FIG. 7B depicts the capture of microplastics capture using hair structures in 3.5 wt % NaCl solution (simulated seawater environment) for a DLP 3D printed hairy cylindrical surface covered in oil (with dye) in accordance with an illustrative embodiment.

FIG. 7C depicts the capture of microplastics capture using hair structures in 3.5 wt % NaCl solution (simulated seawater environment) for a DLP 3D printed hairy flat surface in accordance with an illustrative embodiment.

FIG. 7D depicts the capture of microplastics capture using hair structures in 3.5 wt % NaCl solution (simulated seawater environment) for a DLP 3D printed hairy flat surface covered in oil (with dye) in accordance with an illustrative embodiment.

FIG. 8A depicts microparticles captured by the oil covering on a single fiber in accordance with an illustrative embodiment.

FIG. 8B depicts microparticles captured by the oil trapped between two fibers in accordance with an illustrative embodiment.

FIG. 8C depicts microparticles captured by the oil trapped between multiple fibers in accordance with an illustrative embodiment.

FIG. 9A depicts the process of microplastic ball (d=1.6 mm) falling and being captured by oil secured between two wires in water at time (t)=0 in accordance with an illustrative embodiment.

FIG. 9B depicts the process of microplastic ball (d=1.6 mm) falling and being captured by oil secured between two wires in water at time (t)=30 milliseconds in accordance with an illustrative embodiment.

FIG. 9C depicts the process of microplastic ball (d=1.6 mm) falling and being captured by oil secured between two wires in water at time (t)=60 milliseconds in accordance with an illustrative embodiment.

FIG. 9D depicts the process of microplastic ball (d=1.6 mm) falling and being captured by oil secured between two wires in water at time (t)=90 milliseconds in accordance with an illustrative embodiment.

FIG. 9E depicts the process of microplastic ball (d=1.6 mm) falling and being captured by oil secured between two wires in water at time (t)=120 milliseconds in accordance with an illustrative embodiment.

FIG. 9F depicts schematics of the experiment setup in accordance with an illustrative embodiment.

FIG. 10A depicts a non-hairy porous filter in accordance with an illustrative embodiment.

FIG. 10B depicts a straight hair porous filter in accordance with an illustrative embodiment.

FIG. 10C depicts a Y-shaped hair porous filter in accordance with an illustrative embodiment.

FIG. 10D depicts different example geometries that can be applied to the tip of hairs in accordance with an illustrative embodiment.

FIG. 10E is a top view of a horizontal water channel with filter inserted with indication of flow with particles in accordance with an illustrative embodiment.

FIG. 10F depicts a vertical cylindrical channel, with a filter to remove microparticles in accordance with an illustrative embodiment.

FIG. 11A is a side view of particle behavior for a 0.5 mm spherical particle after being caught with four straight hairs in accordance with an illustrative embodiment.

FIG. 11B is a side view of particle behavior for a 1.5 mm spherical particle after being caught with four straight hairs in accordance with an illustrative embodiment.

FIG. 11C is a side view of particle behavior for a 3 mm spherical particle after being caught with four straight hairs in accordance with an illustrative embodiment.

FIG. 11D is a side view of particle behavior for a 1.5 mm non-spherical particle after being caught with four straight hairs in accordance with an illustrative embodiment.

FIG. 12A depicts microplastic capture (˜0.5 mm) performance of filters by using surfaces with no hair showing in accordance with an illustrative embodiment.

FIG. 12B depicts microplastic capture (˜0.5 mm) performance of filters by using surfaces with straight hairs in accordance with an illustrative embodiment.

FIG. 12C depicts microplastic capture (˜0.5 mm) performance of filters by using surfaces with hairs that have secondary texture in accordance with an illustrative embodiment.

FIG. 13A depicts microplastic capture (˜1.5 mm) performance of filters by using a porous surface with no hair showing (lowest performance) in accordance with an illustrative embodiment.

FIG. 13B depicts microplastic capture (1.5 mm) performance of filters with a porous surface and straight hair in accordance with an illustrative embodiment.

FIG. 13C depicts microplastic capture (1.5 mm) performance of filters with a porous surface and straight hairs having secondary texture (best performance) in accordance with an illustrative embodiment.

FIG. 14A depicts microplastic capture (˜0.5 mm) performance of a system that has multiple cylindrical hairy surfaces with petroleum jelly (e.g., Vaseline) in accordance with an illustrative embodiment.

FIG. 14B depicts microplastic capture (0.5 mm) performance of a system that has straight hairs with small aspect ratio and high density coated with petroleum jelly in accordance with an illustrative embodiment.

FIG. 15A depicts an initial stage of filters before microplastic capture (˜0.5 mm) in accordance with an illustrative embodiment.

FIG. 15B depicts microplastic capture performance of a system in which particles are injected through the inlet in accordance with an illustrative embodiment.

FIG. 15C depicts microplastic capture performance of a system in which premixed DI water with particles is poured in from the top in accordance with an illustrative embodiment.

### DETAILED DESCRIPTION

Plastic debris that are less than five millimeters in length can be referred to as microplastics. Microplastics represent a severe pollution hazard to living organisms and the environment. Their unique characteristics make them difficult to filter out of waterways and/or biodegrade, with serious environmental risks attributed to an increasing accumulation. These plastic particles have been detected in marine organisms as small as plankton and as large as whales, as well as in commercial seafood and drinking water. At the micron scale and in biomedical applications, it is difficult to filter these plastics out of bodily fluids and pharmaceutical solutions. Capturing microplastic particles has been a growing area of research due to the toxic effect they can impose both directly and indirectly to all life forms.

Traditionally, methods used to capture these particles include mesh filters, which typically are clogged as a result of aggregated particles. Filter replacement cycles are therefore shortened, and more energy and funds must be expended for maintenance. Reverse osmosis filters are used to filter microplastics out of drinking water, but are easily clogged and must be replaced often. Other methods include the use of adhesives, nano cellulose fibers, and bubble generation, however, these processes are still quite limited due to high costs. Membrane filters are used in most biomedical applications, but the diffusion of microplastics is limited due to their size. We propose a design using hair-like protrusions and manipulating surface characteristics on flat and cylindrical surfaces using low cost and widely available methods to capture microplastics in aquatic environments.

Microplastics are everywhere and are especially present in large bodies of water as a result of waste. Many industries, including skin care and fashion products, generate high volumes of microplastics daily. Microplastics are also found in wastewater from homes as a result of washing polyester garments and plastic kitchen essentials. Exposure to these microplastics can be detrimental to the ecosystem and to human health. The buildup of microplastics in humans is associated with a myriad of diseases and can lead to potential risks like combined toxicity between microplastics and polyfluoroalkyl substances (PFAS). A method to remove these microplastics before consumption or from bodily fluid, may reduce the associated risks.

Traditionally, methods used to capture microplastics include mesh filters, which are intended to use the mesh structure to aggregate particles. Other methods, including the use of adhesives, nano cellulose fibers, and bubble generation, are still quite limited due to high costs. Additionally, membrane filters are used in most biomedical applications. However, traditional techniques for dealing with the microplastic problem have various disadvantages. For example, meshes used to filter/remove microplastics are frequently clogged, and require energy and funds for maintenance. Generating bubbles for microplastics removal requires external energy input, and existing adhesive technology is new with high costs. Membrane filtration is a size based microplastic removal technique, and the microplastics may be on the same scale as or larger than the necessary solutes.

Therefore, there is a need for an effective and efficient way to capture microplastics. Described herein are methods and systems that cure the deficiencies in traditional microplastic removal systems. The proposed technology can be used in oceans, lakes, and rivers, regardless of the salinity of the aquatic environment. The proposed technology can also be used for the filtration of solutions and bodily fluids in biomedical applications. In an illustrative embodiment, the proposed system involves a surface with an increased effective contact area, induced by the geometry of hair-like protrusions, which facilitates the particle capture process. The inventors also developed a capturing mechanism utilizing interfacial force induced by an oil coating. This system has applications for improved material longevity, enhanced energy efficiency, and reduced operating costs.

Oil-coated fibers are ubiquitous and useful for mist elimination, smog capture, and particle collection applications, to name a few. However, the interaction between impacting particles and oil-coated fibers has not been fully understood. As discussed below, a study was conducted regarding the use of two oil-coated parallel fibers to investigate particle capture dynamics. The inventors discovered that changing the amount of oil on the fibers and the spacing between the fibers creates various shapes of oil on the fibers from clam shell or barrel shaped droplets to columns connecting the fibers. On these oil-coated fibers, the inventors explored the effects of particle size and impacting velocity, fiber flexibility, and fluid properties on particle capture dynamics. In particular, flexible fibers deform along the direction that particles impact, decreasing the relative velocity between the impacting particles and fibers, which improves particle capture efficiency compared with rigid fibers. Extending the fundamental understanding of the particle-fiber interaction, it is demonstrated herein that microplastic particles are captured by oil-coated fibers in the air and water more efficiently compared to fibers without oil coating. It is envisioned that the systematic understanding from this study can be applied to larger scale particulate matter and microplastics collection systems.

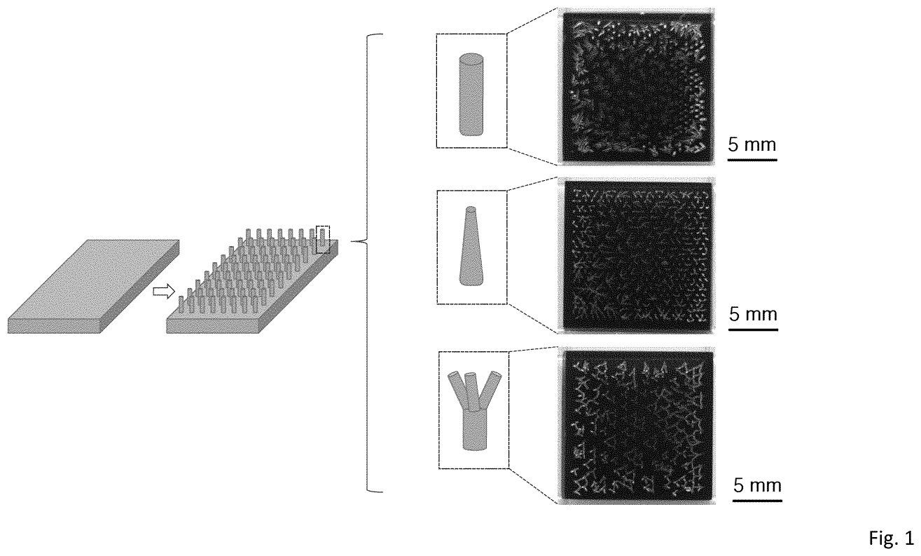

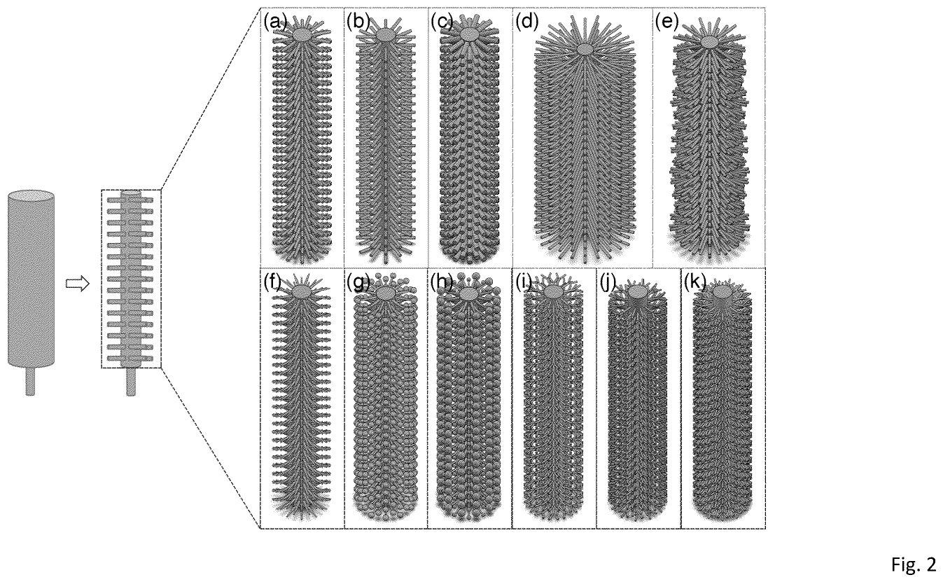

To implement the experiments, the inventors created flat surfaces with hair-like protrusions extending therefrom, and referred to as hairy surfaces. FIG. 1 depicts a substrate, the substrate with hair-like protrusions, and various types of hair-like protrusions in accordance with an illustrative embodiment. The hair-like protrusions have varying aspect ratios, geometries (e.g., cylindrical, conical, etc.), densities, and branch numbers, which increase the effective contact area of the microplastic capture system. FIG. 2 depicts a cylindrical surface with hair-like structures extending therefrom in accordance with an illustrative embodiment. In FIG. 2 the hair-like structures are 3D printed around a column. Alternatively, a different fabrication technique may be used, such as molding, etc. As shown, the hair-like structures vary in density, in aspect ratio, overall shape, and branch number. Barring significant obstructions, it was found that more particles are captured with a larger contact area. Since the material and shape of a surface determines the quantity of microplastic particles captured by the surface, the experiments conducted compare the effectiveness of various materials and geometries in capturing microplastic particles.

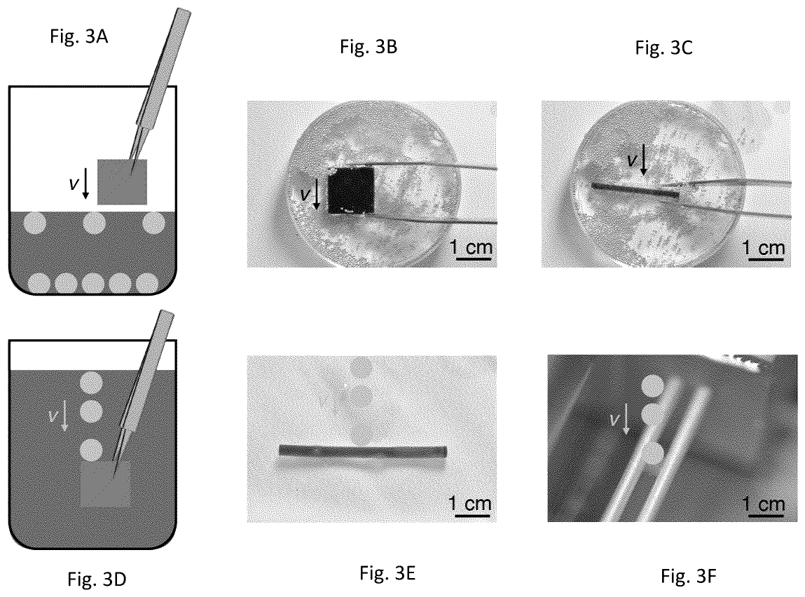

A first capture process was developed in which the hair-like protrusions collect particles through movement in an aqueous environment. In FIGS. 3A-3C, the hairy surface is moved within the aqueous solution to collect microplastics. Specifically, FIG. 3A depicts insertion of a hairy surface into an aqueous environment with microplastics in accordance with an illustrative embodiment. FIG. 3B depicts first movement of the hairy surface within the aqueous environment in accordance with an illustrative embodiment. FIG. 3C depicts second movement of the hairy surface within the aqueous environment in accordance with an illustrative embodiment. In FIGS. 3D-3F, the solution flows over/through the hairy surface. FIG. 3D depict insertion of the hairy surface into a flowing aqueous solution in accordance with an illustrative embodiment. FIG. 3E depicts a first flow direction of the aqueous solution relative to the hairy surface in accordance with an illustrative embodiment. FIG. 3F depicts a second flow direction of the aqueous solution relative to the hairy surface in accordance with an illustrative embodiment.

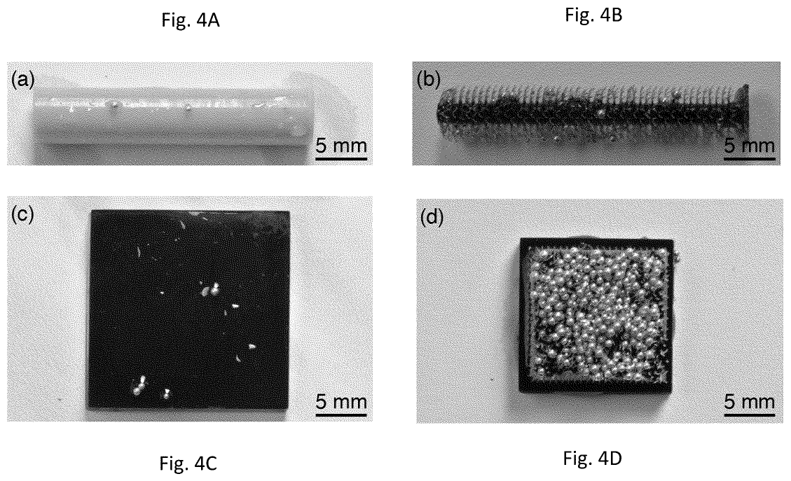

While both 3D printed hairy surfaces and 3D printed smooth surfaces have the ability to collect microplastic particles, it was seen from experiments that hairy surfaces collect larger quantities of microplastic particles than flat surfaces under equivalent conditions. The increased surface area allows for larger effective contact area, and the interfacial forces between the particle and the increased contact area allow for more particles to be captured. FIG. 4A depicts the capture of a plurality of microplastic particles on a smooth cylindrical surface in accordance with an illustrative embodiment. FIG. 4B depicts the capture of microplastic particles on a hairy cylindrical surface in accordance with an illustrative embodiment. FIG. 4C depicts the capture of microplastic particles on a smooth flat surface in accordance with an illustrative embodiment. FIG. 4D depicts the capture of microplastic particles on a hairy flat surface in accordance with an illustrative embodiment. It was found that the hairy structures capture more microplastics than the flat surfaces.

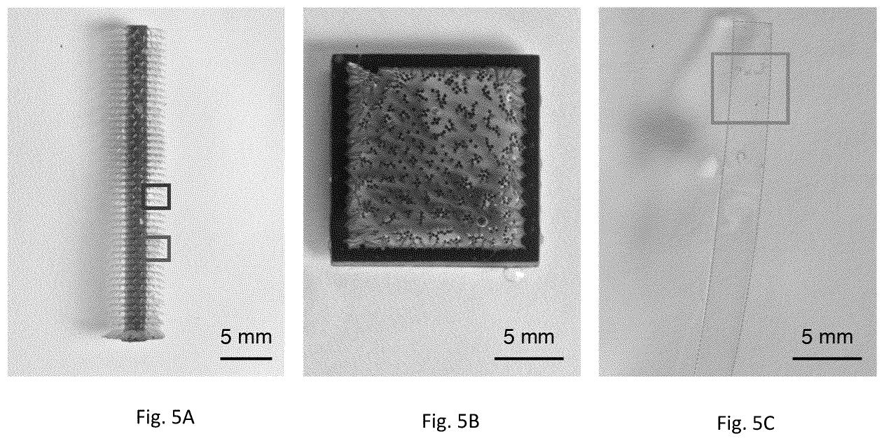

In one experiment, dyed oil droplets were collected using a 3D printed hairy cylindrical surface, a 3D printed hairy flat surface, and a polydimethylsiloxane (PDMS) smooth flat surface. On the hairy cylindrical surface, areas with wetting and non-wetting behavior were observed, defined as partial wetting. In this case, oil droplets do not form a uniform film on the surface, essentially remaining in droplet form. While the resin used for the 3D printed surfaces is to an extent oleophilic, the hair-like protrusions increase the effective area thus increasing the interfacial forces between the oil and the surfaces. On the PDMS smooth flat surface, total wetting was found due to the oleophilicity of PDMS, where the film of collected oil is distributed uniformly across the surface. FIG. 5A depicts the shape that oil (with dye) takes in DI water, when the oil droplet attaches to a DLP 3D printed hairy cylindrical surface in accordance with an illustrative embodiment. In FIG. 5A, a non-wetting region is shown with an upper box, and a partial-wetting region is shown with a lower box. FIG. 5B depicts the shape that oil (with dye) takes in DI water, when the oil droplet attaches to a DLP 3D printed hairy flat surface in accordance with an illustrative embodiment. FIG. 5C depicts the shape that oil (with dye) takes in DI water, when the oil droplet attaches to a PDMS surface in accordance with an illustrative embodiment. In FIG. 5C, the dashed line shows the boundary of PDMS. In FIG. 5C, a total-wetting region is shown with a box.

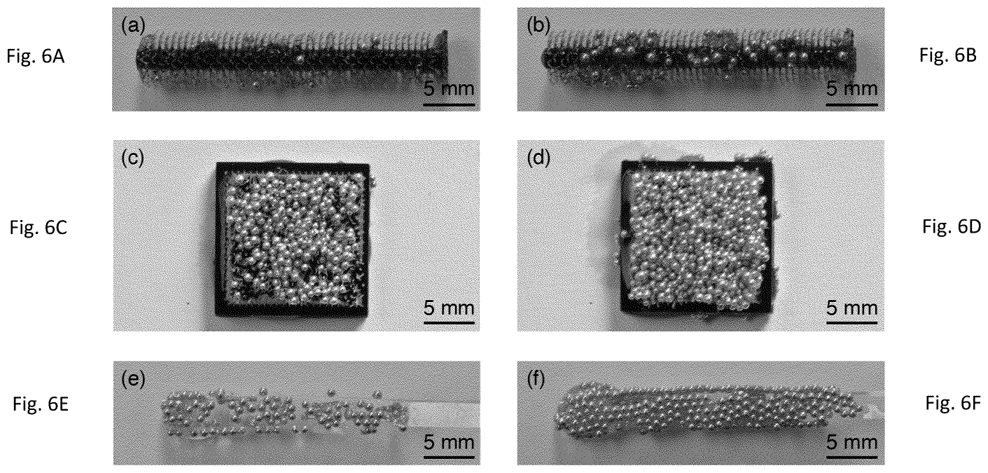

Coating a surface with oil was found to increase the number of microplastic particles captured by a surface in the case of 3D printed hairy cylindrical surface geometry, 3D printed hairy flat surface geometry, and smooth flat PDMS. FIG. 6A depicts the capture of a plurality of microplastics particles for a DLP 3D printed hairy cylindrical surface in accordance with an illustrative embodiment. FIG. 6B depicts a DLP 3D printed hairy cylindrical surface covered in oil (with dye) in accordance with an illustrative embodiment. FIG. 6C depicts a DLP 3D printed hairy flat surface in accordance with an illustrative embodiment. FIG. 6D depicts a DLP 3D printed hairy flat surface covered in oil (with dye) in accordance with an illustrative embodiment. FIG. 6E depicts a smooth flat PDMS surface in accordance with an illustrative embodiment. FIG. 6F depicts a smooth flat PDMS surface covered in oil (with dye) in accordance with an illustrative embodiment. In testing these surfaces, it was found that equivalent samples with oil outperform the samples without oil.

The experiments reveal that there is a larger attraction between the oil and particle than the water and particle because microplastics are oleophilic. The non-polarity of the oil and microplastics attract each other greater than the polarity of water and the non-polarity of the microplastics. This technology simulates the concepts of biofilms and biofouling, which result from a surface's long-term exposure to organic or biological material, and have significant capture ability. Oil functions in a similar manner to biofilms and biofouling. Moreover, an aquatic environment in nature is usually not as pure as DI water. Aquatic systems with high salinity have a higher disjoining pressure than those of low salinity, increasing the difficulty of capturing microplastics out of the aquatic environment. In a simulated seawater environment of 3.5 wt % sodium chloride (NaCl) solution, the oil-coated surfaces collected a larger quantity of microplastic particles than the non-coated surfaces, indicating that this method is feasible to collect and remove microplastic particles from seawater.

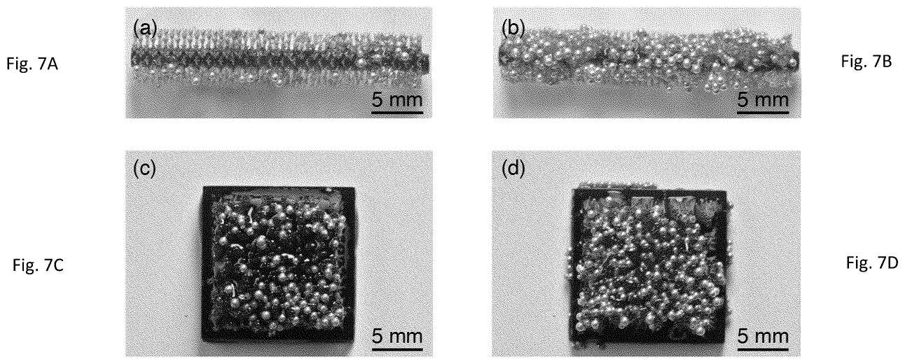

FIG. 7A depicts the capture of microplastics capture using hair structures in 3.5 wt % NaCl solution (simulated seawater environment) for a DLP 3D printed hairy cylindrical surface in accordance with an illustrative embodiment. FIG. 7B depicts the capture of microplastics capture using hair structures in 3.5 wt % NaCl solution (simulated seawater environment) for a DLP 3D printed hairy cylindrical surface covered in oil (with dye) in accordance with an illustrative embodiment. FIG. 7C depicts the capture of microplastics capture using hair structures in 3.5 wt % NaCl solution (simulated seawater environment) for a DLP 3D printed hairy flat surface in accordance with an illustrative embodiment. FIG. 7D depicts the capture of microplastics capture using hair structures in 3.5 wt % NaCl solution (simulated seawater environment) for a DLP 3D printed hairy flat surface covered in oil (with dye) in accordance with an illustrative embodiment. It is noted that human blood has a salinity of 0.9 wt % NaCl and a disjoining pressure between pure water and 3.5 wt % NaCl. This method is therefore feasible to capture and remove microplastic particles from various aqueous liquids, including pure water, blood, seawater, etc.

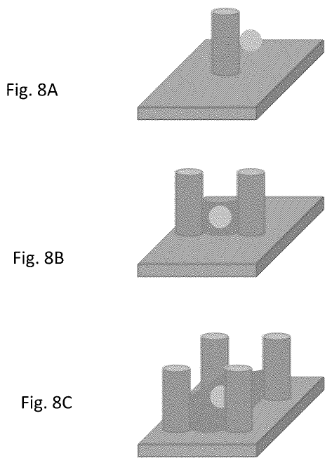

To enhance the capture of microplastic particles by oil coated hair-like protrusions, it was found that additional hair-like protrusions could be added to secure the oil droplet. FIG. 8 depicts a method to enhance the ability to capture microplastics with oil-covered hair, through the addition of hairs to the surface. FIG. 8A depicts microparticles captured by the oil covering on a single fiber in accordance with an illustrative embodiment. FIG. 8B depicts microparticles captured by the oil trapped between two fibers in accordance with an illustrative embodiment. FIG. 8C depicts microparticles captured by the oil trapped between multiple fibers in accordance with an illustrative embodiment.

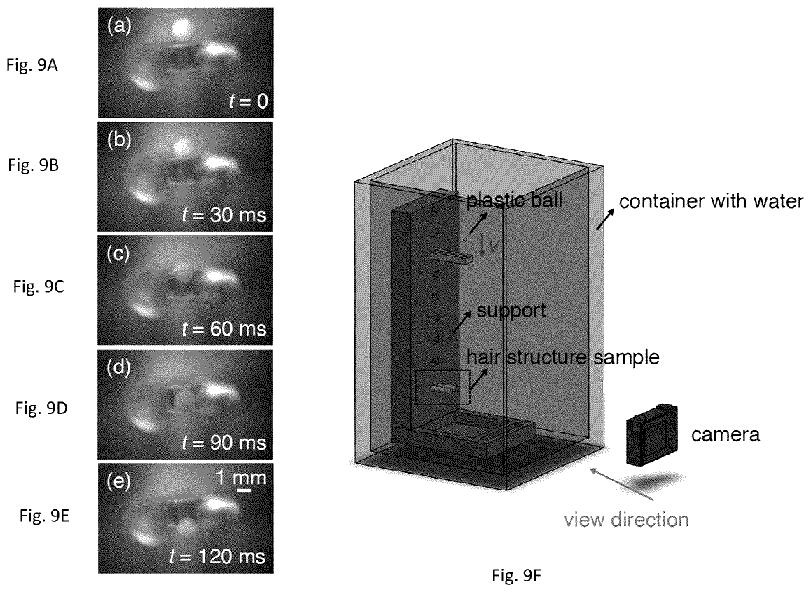

Adding hair-like protrusions increases the effective contact area through which oil droplets may be captured and held through interfacial forces. When oil is secured between multiple hair-like protrusions, a moving microplastic particle can be captured. FIG. 9A depicts the process of microplastic ball (d=1.6 mm) falling and being captured by oil secured between two wires in water at time (t)=0 in accordance with an illustrative embodiment. FIG. 9B depicts the process of microplastic ball (d=1.6 mm) falling and being captured by oil secured between two wires in water at time (t)=30 milliseconds in accordance with an illustrative embodiment. FIG. 9C depicts the process of microplastic ball (d=1.6 mm) falling and being captured by oil secured between two wires in water at time (t)=60 milliseconds in accordance with an illustrative embodiment. FIG. 9D depicts the process of microplastic ball (d=1.6 mm) falling and being captured by oil secured between two wires in water at time (t)=90 milliseconds in accordance with an illustrative embodiment. FIG. 9E depicts the process of microplastic ball (d=1.6 mm) falling and being captured by oil secured between two wires in water at time (t)=120 milliseconds in accordance with an illustrative embodiment.

FIG. 9F depicts schematics of the experiment setup in accordance with an illustrative embodiment. As shown, a camera is used to monitor the interaction of a plastic ball with a support structure that includes hair-like structures extending therefrom. The support structure, hair-like structures, and plastic ball are positioned in a container filled with water. The oil and hair-like protrusions capture the microplastic particle due to interfacial forces. These forces oppose the force generated by the momentum of the particle resulting in a zero velocity and ultimate capture of the particle. In the case that the particle velocity is less than a critical velocity, the oil remains coated on the hair-like protrusions due to surface tension.

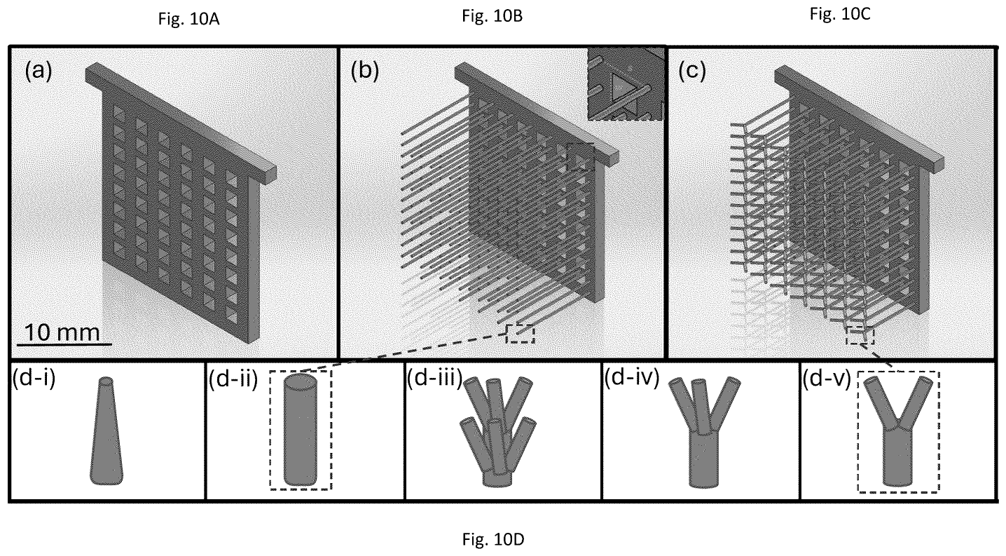

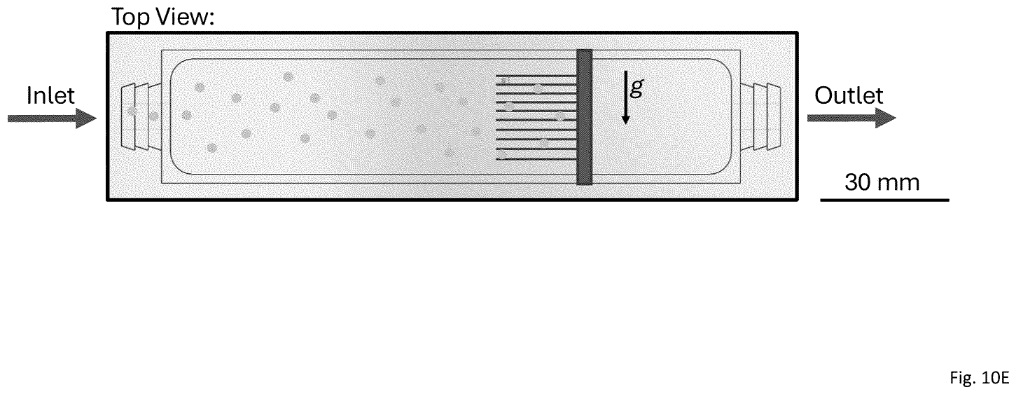

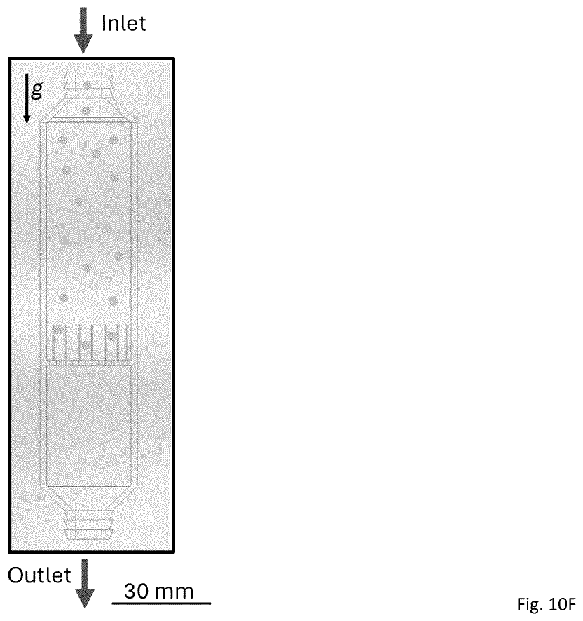

In another experiment, higher aspect ratio hairs and different geometries were tested in a water tunnel with particles inserted into a flow, and the results showed capture performing capabilities. In this embodiment, the substrate (or base) was made porous to allow for water or another fluid to flow through downstream while microparticles are captured upstream upon contact with hair-like extensions that protrude from the base. This setup allows for feasible microplastic capture in applications that involve a closed channel or water flow. FIG. 10A depicts a non-hairy porous filter in accordance with an illustrative embodiment. FIG. 10B depicts a straight hair porous filter in accordance with an illustrative embodiment. As shown, the straight hairs extend upstream (relative to the direction of flow) from the base. FIG. 10C depicts a Y-shaped hair porous filter in accordance with an illustrative embodiment. FIG. 10D depicts different example geometries that can be applied to the tip of hairs in accordance with an illustrative embodiment. Specifically, the geometries include a truncated cone, a cylinder, a set of 6 cylinders, a set of 3 cylinders, a set of 2 cylinders (Y-configuration), etc.

FIG. 10E is a top view of a horizontal water channel with filter inserted with indication of flow with particles in accordance with an illustrative embodiment. FIG. 10F depicts a vertical cylindrical channel, with a filter to remove microparticles in accordance with an illustrative embodiment. It is noted that the setup and performance of the system is independent of the direction of gravity. As shown, the embodiment of FIGS. 10E and 10F includes a housing in which the base is mounted. As shown, the housing includes an inlet for fluid flow and an outlet for fluid flow, and the hair-like protrusions/extensions extend from an upstream facing side of the base. In one embodiment, the hair-like protrusions have varying aspect ratios across the base. In another embodiment, the hair-like protrusions have varying shapes along the base. Additionally, a density of the hair-like protrusions can vary along the base in some embodiments. As discussed herein, the hair-like protrusions can also have one or more secondary branch extensions that extend therefrom.

In one embodiment, the filter system of FIG. 10 can include one or more surfactants on its interior surfaces (e.g., on the housing and/or the base) to further help particle collection. In another embodiment, the filter system may eventually become clogged after collecting numerous particles. To restore the filter, a backwashing procedure in which the fluid flow through the filter is reversed, can be used to remove particles from the hair-like structures. In another embodiment, the filter can be cleaned by submersion in an oil bath. The submersed filter can be agitated to remove collected particles, which are attracted to the oil in the oil bath. The oil bath can also help to recoat the hair-like structures, in the event that any oil coating was washed away during filtering. In another embodiment, an inner surface of the filter system of FIG. 10 can include an accordion structure with peaks and valleys. As the liquid flows through the filter, particles can drop into and be collected in the valleys of the accordion. The accordion structure and/or other inner surfaces of the filter can include surfactants, oil coating, etc. to help collect additional particles from the flow.

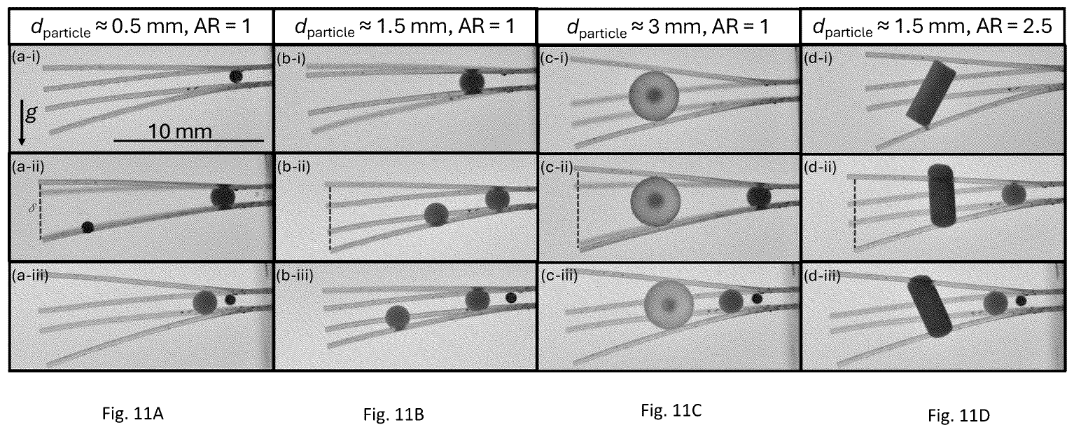

It was also found that higher aspect ratio hairs lead to increased surface area and flexibility of the hairs, which leads to increased effective contact area for interaction of particle and hair. FIG. 11A is a side view of particle behavior for a 0.5 mm spherical particle after being caught with four straight hairs in accordance with an illustrative embodiment. FIG. 11B is a side view of particle behavior for a 1.5 mm spherical particle after being caught with four straight hairs in accordance with an illustrative embodiment. FIG. 11C is a side view of particle behavior for a 3 mm spherical particle after being caught with four straight hairs in accordance with an illustrative embodiment. FIG. 11D is a side view of particle behavior for a 1.5 mm non-spherical particle after being caught with four straight hairs in accordance with an illustrative embodiment. FIG. 11 demonstrates the relationship between diameter of particle and spacing (1.5 mm between hair-like structures), and how the flexibility of the hairs increases the range of diameter of particles captured in addition to capture of microplastics with different surface morphologies or aspect ratios (fragments, flakes, fibers, etc.). These particles with different morphologies may even have a higher potential of capture due to an increase in faceted sides of the particles resulting in more points of contact, thus increased interaction between particle and hair leading to ultimate capture. Also, the flexibility of the hairs increases the range of particle sizes captured with particles smaller and larger than the spacing captured due to the deformation (δ).

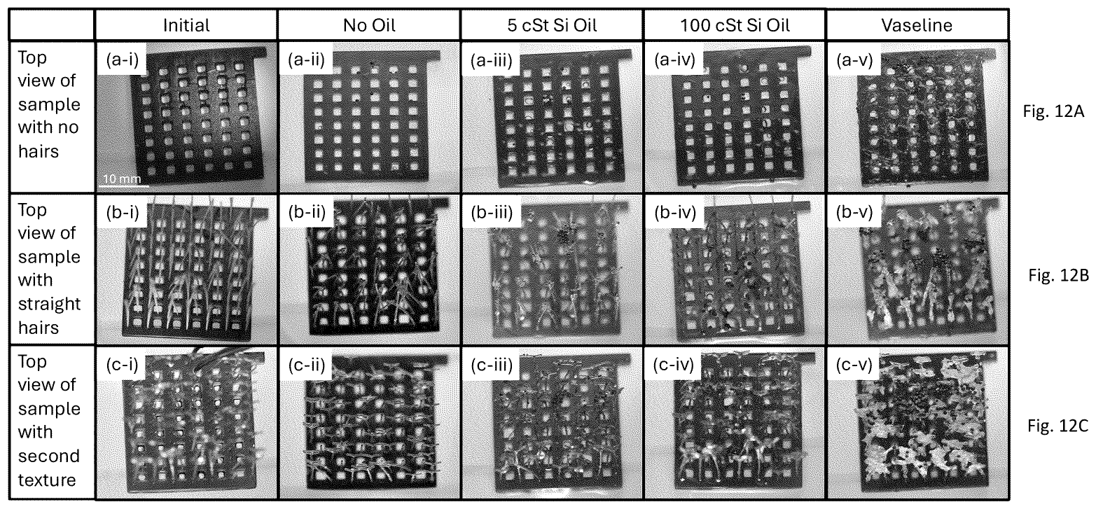

FIG. 12A depicts microplastic capture (˜0.5 mm) performance of filters by using surfaces with no hair showing in accordance with an illustrative embodiment. FIG. 12B depicts microplastic capture (˜0.5 mm) performance of filters by using surfaces with straight hairs in accordance with an illustrative embodiment. FIG. 12C depicts microplastic capture (˜0.5 mm) performance of filters by using surfaces with hairs that have secondary texture in accordance with an illustrative embodiment. The results show that the system of FIG. 12A (no hairs) had the lowest performance, and the system of FIG. 12C (hairs with secondary textures) had the highest performance.

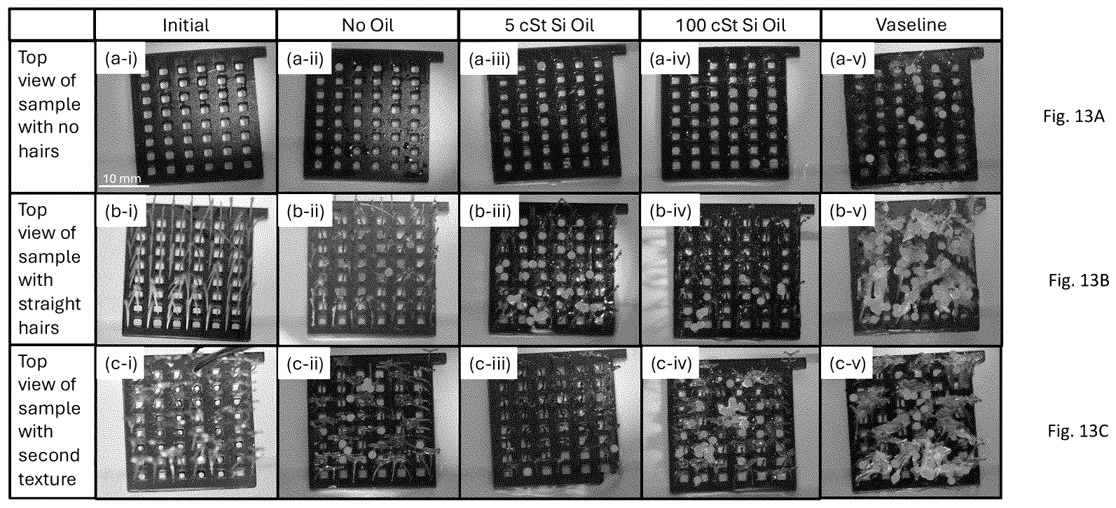

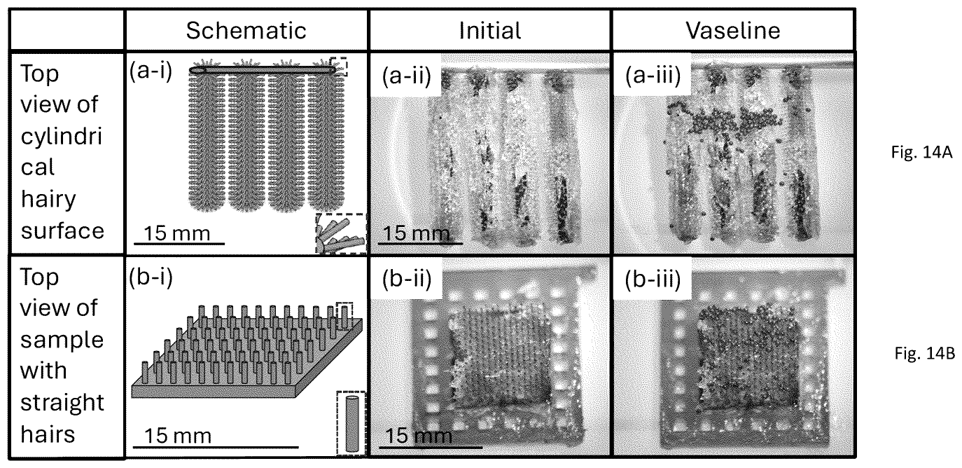

The longer hairs in addition to different oil coating viscosities demonstrated enhancement of capture of microplastic particles of different sizes, as shown in FIGS. 12 and 13. The increase contact area of long hairs and interfacial forces introduced by a viscous coating enable forces great enough to oppose the force generated by the momentum of the particles. As shown in FIGS. 12 and 13, samples coated with oil showed higher capture performance than samples with no oil. As the viscosity of the coating increases so does the capture performance, with samples coated with petroleum jelly having the highest capturing ability. Silicone oils were also used. Petroleum jelly is a semi-solid at room temperature, it can hold its shape but can be moldable and forced to take the shape of its container. In addition to this unique characteristic, its immiscibility with water poses a strong interaction between coating the hair and aiding in capture of particles. Hairs with secondary texture and highest viscosity coating resulted in the highest capture performance.

FIG. 13A depicts microplastic capture (˜1.5 mm) performance of filters by using a porous surface with no hair showing (lowest performance) in accordance with an illustrative embodiment. FIG. 13B depicts microplastic capture (1.5 mm) performance of filters with a porous surface and straight hair in accordance with an illustrative embodiment. FIG. 13C depicts microplastic capture (1.5 mm) performance of filters with a porous surface and straight hairs having secondary texture (best performance) in accordance with an illustrative embodiment. In addition, this orientation of cylindrical hairy samples shows the case in scalability. The water channel setup was also applied to denser and shorter hairs previously tested. These filters exhibited capturing capabilities and allowed water to flow through downstream around the hairs.

Use of petroleum jelly and the water channel can be applied to any of the systems described herein. For example, in one embodiment, cylindrical hairy samples can be placed in a line to fit in between the walls of the channel. This in plane orientation of the cylindrical hairy surfaces demonstrated capturing abilities while being porous in between the center rods to allow for cleaner water to flow downstream. FIG. 14A depicts microplastic capture (˜0.5 mm) performance of a system that has multiple cylindrical hairy surfaces with petroleum jelly (e.g., Vaseline) in accordance with an illustrative embodiment. FIG. 14B depicts microplastic capture (0.5 mm) performance of a system that has straight hairs with small aspect ratio and high density coated with petroleum jelly in accordance with an illustrative embodiment. Both systems show particle capture capabilities while being hairy and porous.

Particles can be incorporated many ways into the water channel to interact with the hairy surfaces. Prior testing relied on pouring particles in from the top of the channel. Further testing investigated other methods of incorporating particles. Particles can be injected into the channel by placing particles in the inlet tube and allowing the flow of the water to carry the particles through the channel. Particles can also be premixed in water and poured in from the top of the channel. Both methods allow for particles to be incorporated throughout the water, though injecting the particles showed the best performance for incorporating the particles to interact with the hairy surfaces downstream.

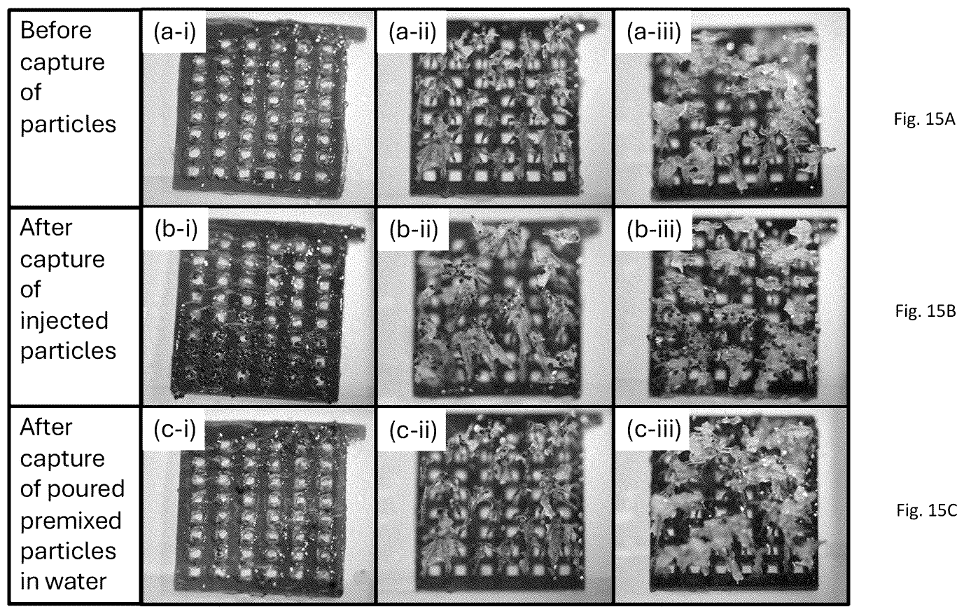

FIG. 15A depicts an initial stage of filters before capture of microplastics in accordance with an illustrative embodiment. FIG. 15B depicts microplastic capture (˜0.5 mm) performance of a system in which particles are injected through the inlet in accordance with an illustrative embodiment. FIG. 15C depicts microplastic capture performance of a system in which premixed DI water with particles is poured in from the top in accordance with an illustrative embodiment.

Through the experiments, it was found that the proposed system has a broad microplastics capture effect regardless of if it is used in freshwater, seawater, brine, saline, biological fluids, or wastewater. Compared with other high-energy input methods, like collecting microplastics using bubbles, the proposed system requires considerably less energy input and lower costs. The system also has the advantage of capturing microplastic particles that may be larger than the size exclusion threshold of traditional membrane filtration systems.

Three-dimensional (3D) printing is an established and commonly-used process in additive manufacturing. Typical 3D printing techniques includes stereolithography (SLA), digital light processing (DLP), liquid crystal display (LCD), selective laser sintering (SLS), and fused deposition modeling (FDM), etc. Common 3D printing materials used for FDM printers includes Polylactic Acid (PLA), Acrylonitrile Butadiene Styrene (ABS), Polyethylene Terephthalate Glycol (PETG), Thermoplastic Polyurethane (TPU), Polycarbonate (PC) Filament. Composite materials (such as PLA filaments) filled with metal or wood powder can give the printed design a more special look and properties (e.g. Young's modulus). Resin, metal powders, and ceramic powders are wildly used for SLA and DLP printers. This results in accessible large-scale manufacturing for these customized surfaces at lower costs than other methods. Recently, more and more complicated structures (such as tiny sponge-like porous structures and metal/covalent-organic frameworks (M/COFs)) can be printed in a wider range in size, from nanoscale to macroscale. Similarly, PDMS or other silicone rubbers/elastomers are widely available and low-cost affording it the same large scale manufacturing capabilities. The silicone oil, petroleum jelly, or other oil (e.g. mineral oil and lubricating oil) used for the coating is low cost, with low toxicity and long-term stability. In some embodiments, oil coatings could be induced as a biofilm by exposing the hair structure to organic/biological materials.

Thus, as discussed above, current microplastics capture methods pose various disadvantages such as short service life, additional energy inputs, and high costs. Of these methods, clogged filters are a frequent issue and result in increased waste production requiring replacements. As a consequence, an environmentally friendly, low-cost, and scalable microplastics capture mechanism is required. The system described herein includes a surface with an increased effective contact area induced by the geometry of hair-like protrusions. The increased effective contact area increases the efficiency of particle capture. In one embodiment, the system includes a capturing mechanism utilizing adhesion induced by interfacial forces with an oil coating. This system has applications for improved material longevity, enhanced energy efficiency, and reduced operating costs. This system utilizes the special geometry of hair-like protrusions to increase the effective contact area between particles and the capturing tool during the microplastics capture process. Besides the mechanical force, the additional surface tension force is induced by the oil layer coated on the hair-like protrusions, which increases the microplastics capture ability.

The proposed system can be used in a variety of different applications, including boats, submarines, ships, etc., home appliances including washing machines and water tanks, plumbing, wastewater treatment facilities, water purifiers for industrial and residential purposes, attachments to faucets for baths and sinks, hemodialysis treatments, filtering solutions for pharmaceutical development, etc.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A microplastic capture system comprising:
a base;
a plurality of hair-like protrusions mounted to and extending from the base; and
oil applied to the plurality of hair-like protrusions, wherein the oil and hair-like protrusions are positioned to capture microplastic particles due to interfacial forces that oppose a force generated by momentum of the microplastic particles.

2. The system of claim 1, wherein the hair-like protrusions have varying aspect ratios across the base.

3. The system of claim 1, wherein the hair-like protrusions have varying shapes along the base.

4. The system of claim 1, wherein a density of the hair-like protrusions varies along the base.

5. The system of claim 1, wherein the hair-like protrusions have one or more secondary branch extensions that extend therefrom.

6. The system of claim 1, wherein the base has a plurality of through-holes such that fluid is able to flow through the base.

7. The system of claim 6, wherein the hair-like protrusions extend from an upstream facing side of the base.

8. The system of claim 1, wherein the base is incorporated into a housing that includes an inlet for fluid flow and an outlet for the fluid flow.

9. The system of claim 8, wherein an inner surface of the housing includes a surfactant coating to attract the microplastic particles.

10. The system of claim 1, wherein the hair-like protrusions have a truncated cone shape.

11. The system of claim 1, wherein the hair-like protrusions have a cylindrical shape.

12. A method of forming a microplastic capture system, the method comprising:
forming a base;
forming a plurality of hair-like protrusions that extend from the base; and
applying an oil to the plurality of hair-like protrusions, wherein the oil and hair-like protrusions are positioned to capture microplastic particles due to interfacial forces that oppose a force generated by momentum of the microplastic particles.

13. The method of claim 12, further comprising forming the hair-like protrusions to have varying aspect ratios across the base.

14. The method of claim 12, further comprising forming the hair-like protrusions to have varying shapes along the base.

15. The method of claim 12, further comprising varying a density of the hair-like protrusions along the base.

16. The method of claim 12, further comprising forming one or more secondary branch extensions that extend from the hair-like protrusions.

17. The method of claim 12, further comprising forming a plurality of through holes in the base such that fluid is able to flow through the base.

18. The method of claim 17, further comprising forming the hair-like protrusions such that the hair-like protrusions extend from an upstream facing side of the base.

19. The method of claim 12, further comprising mounting the base in a housing that includes an inlet for fluid flow and an outlet for the fluid flow.

20. The method of claim 19, further comprising applying a surfactant coating to an inner surface of the housing to attract the microplastic particles.
